(19) United States
(12) Patent Application Publication
(10) Pub. No.: US 2005/0045160 A1
(43) Pub. Date: Mar. 3, 2005

(54) Evaporative emissions canister with incorporated liquid fuel trap

(76) Inventors: Alicia Peterson, Rochester Hills, MI (US); Christopher D. Allen, Eastpointe, MI (US); Anthony R. St. Amour, Dearborn Heights, MI (US); John M. Hamilton, Grand Blanc, MI (US)

Correspondence Address: DAYCO PRODUCTS, LLC, 1 PRESTIGE PLACE, MIAMISBURG, OH, 45342, US

(21) Appl. No.: 10/655,240

(22) Filed: Sep. 3, 2003

(51) Int. Cl. F02M 33/02

(52) U.S. Cl. 123/519

(57) ABSTRACT

An evaporative emissions canister for use in an automotive evaporative emission system to control emission of fuel vapors to the atmosphere, the system including a fuel tank coupled to an automotive engine, the canister comprising: a housing having side walls, a top wall and a bottom wall; a hydrocarbon-adsorbing material disposed so as to provide a vapor adsorbent chamber for adsorbing hydrocarbon fuel vapor flowing therethrough; and separating means located adjacent the vapor adsorbent chamber for separating fuel vapor and liquid fuel.

### BACKGROUND OF THE INVENTION

The present invention relates to a fuel system for an internal combustion engine and, particularly, to an evaporation emissions canister which includes an integral liquid fuel trap for improved separation of liquid fuel which is entrained along with the fuel vapor to the evaporative emissions canister in the fuel system.

Presently, fuel systems employed in the automotive industry contain an evaporative emissions canister to control evaporative emissions from the automotive fuel tank. Examples of evaporative emissions canisters are described in U.S. Pat. No. 4,203,401 to Kingsley et al.; U.S. Pat. No. 5,408,977 to Cotton; U.S. Pat. No. 5,924,410 to Dumas et al.; U.S. Pat. No. 5,957,114 to Johnson et al; U.S. Pat. No. 6,136,075 to Bragg et al; and U.S. Pat. No. 6,237,574 to Jamrog et al. Typically, the evaporative emissions canisters include an adsorbent material such as activated carbon to adsorb the fuel vapors emitted from the fuel tank. The carbon filled canister adsorbs the fuel vapor until it becomes saturated, at which time, fresh air drawn through the canister removes the fuel vapor therefrom and sends it to the engine by means of suitable conduits and flow control devices. Such fuel systems not only permit the vapor to flow to the canister but also have the potential to allow liquid fuel to travel from the fuel tank to the canister where it saturates at least a portion of the adsorbent carbon bed causing the carbon to become non-functional until the liquid is evaporated and purged. This decreases the overall working capacity of the canister resulting in possible emissions to the atmosphere. To prevent this, most fuel systems have a liquid fuel trap which is designed to allow the liquid to enter the canister but will not allow it to enter the carbon bed. Once the liquid enters the liquid fuel trap it simply sits there until it either evaporates on its own due to the properties of the gasoline or it will be drawn out of the canister during the purge cycle of the vehicle and conveyed back to the engine where it is consumed.

Evaporative emissions canisters with incorporated fuel traps have been manufactured by mounting the fuel trap onto the top of the canister, providing a basin for any invasive liquid fuel. For example, U.S. Pat. No. 5,119,791 to Gifford, et al. specifically teaches the use of a liquid trap with a vapor storage canister. However, such canisters generally require that an additional welding step be performed in the manufacture of the canister/liquid fuel trap system, wherein a seal is created between the fuel trap and the canister. Typically, the fuel trap is installed into the canister via a plastic welding process such as vibration welding, ultrasonic welding, etc.

It is apparent from the above that there exists a need in the art for an automotive evaporative emissions canister which effectively prevents liquid fuel from entering and saturating the carbon bed in the canister, and which also eliminates the requirement for an additional sealing step between the fuel separator and the canister in the manufacturing process.

Accordingly, it is a primary object of this invention to provide an improved evaporative emissions system which incorporates a vapor/liquid separator in the fuel system which is operative to prevent liquid fuel from entering the carbon bed.

It is another object of the invention to provide an evaporative emissions canister which eliminates the requirement for an additional step in the manufacturing process to provide a seam between the fuel separator and the canister.

These objects as well as other objects, features and advantages of the present invention will be apparent to those skilled in the art from the following detailed description, appended claims and accompanying drawings.

### SUMMARY OF THE INVENTION

In the past, canisters with incorporated fuel traps have been manufactured by mounting the fuel trap into the top of the canister creating the basin. Typically, a seal is created between the canister and the fuel trap by a plastic welding process such as vibration welding, ultrasonic welding, etc. The creation of the seal between the canister and the fuel trap is undesirable in that it requires an additional time consuming and, therefore, manufacturing step. The liquid trap of the present invention does not require “outside help” for installation into the system.

In accordance with the present invention, the liquid fuel trap is incorporated directly into the evaporative emissions canister body by pressure fitting the fuel trap into the canister housing, wherein the seal is maintained by creating a torturous path for the liquid molecules via a groove inside the canister into which the fuel trap or basin is located, thereby eliminating the vibration welding step. The elimination of the welding step also reduces labor and capital costs because there is no need for welding equipment or operators.

### BRIEF DESCRIPTION OF THE DRAWINGS

FIG. 1 is a schematic illustration of an evaporative emission system of a combustion engine according to the present invention;

FIG. 2 is a perspective view of an evaporative emissions canister of the evaporative emissions systems of FIG. 1; and

FIG. 3 is an enlarged view of Section A of FIG. 2.

### DETAILED DESCRIPTION OF THE INVENTION

Vehicle fuel systems require liquid traps to prevent liquid fuel from entering the carbon bed of the vapor canister. Without the liquid trap, there is the potential for liquid fuel to enter the canister. If this were to happen, the carbon bed would quickly degrade to a point that it would no longer be useful.

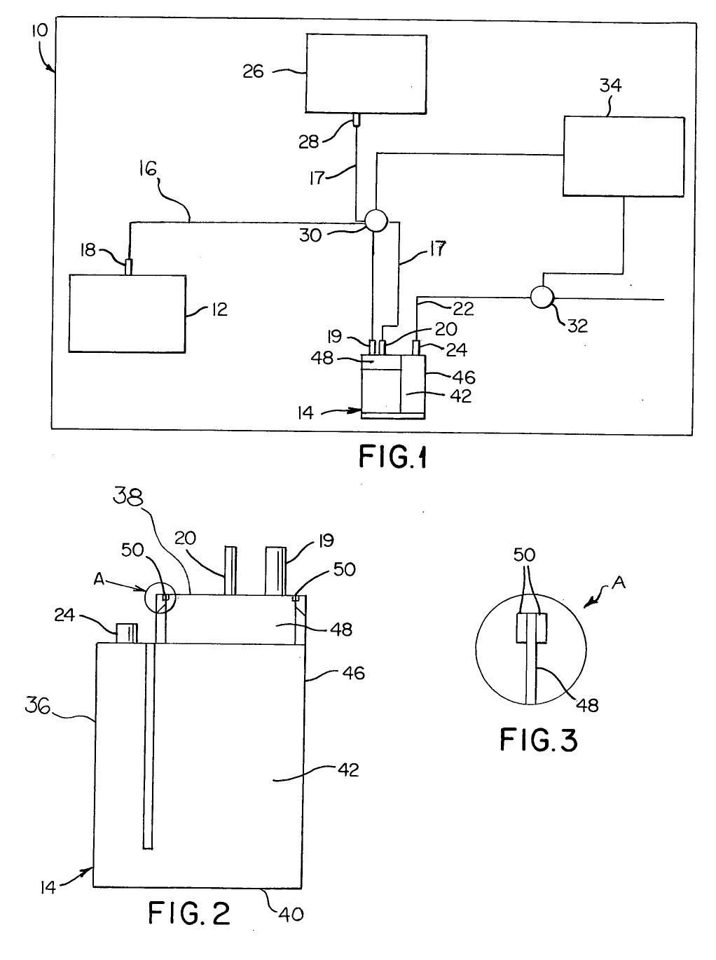

Turning to the drawings, FIG. 1 is a schematic illustration of an evaporative emissions system for an automotive vehicle. As illustrated in FIG. 1, the evaporative emissions system 10 includes an evaporative emissions canister 14 containing a bed of adsorbent material 42. Fuel vapor including a small amount of liquid fuel vented from the fuel tank 12 flows through the fuel vapor line 16 which communicates with fuel tank 12 via port 18 and with canister 14 via port 19. Fuel vapor containing anywhere from a minor amount to a significant amount of liquid fuel is vented from the fuel tank 12 where it flows through fuel vapor line 16 to the canister 14. In accordance with the present invention, the liquid fuel is separated from the fuel vapor allowing the fuel vapor to be adsorbed by the bed of adsorbent material 42. The adsorbed fuel vapor is then purged from the adsorbent material 42 by applying engine vacuum on the bed of adsorbent material 42, drawing air through the adsorbent material 42 containing the fuel vapor. The desorbed fuel vapor is then fed to the engine 26 through engine vacuum line 17, and burned. More specifically, one end of the fuel vapor load line 16 is connected to the fuel tank 12 via port 18 and the other end is connected to the canister 14 via port 19. The fuel vapor, including a minor amount of liquid fuel enters the canister at port 19 where the fuel vapor is separated from any liquid fuel. The fuel vapor is passed on to the adsorbent chamber 46 where it is adsorbed on the adsorbent material 42, while the liquid fuel is drawn by gravity to a liquid fuel trap 48 where it remains until it evaporates.

When the adsorbent material 42 becomes saturated with the fuel vapor, engine controller 34 commands fuel vapor valve 30 to close the fuel vapor load line 16 so that the fuel vapor is desorbed from the adsorbent material 42 and drawn by vacuum through an engine vacuum port 28 connecting engine vacuum line 17 to the engine 26 where the desorbed fuel vapor is consumed. The vacuum created by opening the fresh air valve 32 also causes fresh air from the atmosphere to be drawn into the canister 14 through fresh air line 22 connected to canister 14 via port 24. Upon removal of the fuel vapor from the adsorbent material 42, the fuel vapor valve 30 is opened so that additional fuel vapor from the fuel tank 12 can be transported via fuel vapor load line 16 to the canister 14 and adsorbed by the adsorbent material 42. Fresh air is then forced back through fresh air line 22 to the atmosphere. The fresh air valve 32 is opened and closed by the engine controller 34 to prevent fuel vapor from escaping into the atmosphere. However, the fresh air valve 32 typically remains open until routine or diagnostic steps are performed on the automotive vehicle.

As shown in FIG. 2, the canister 14 includes a housing having a side portion 36, a top portion 38 and a bottom portion 40. The canister 14 further includes a liquid fuel trap 48 and an adsorbent chamber 46. The fuel vapor entering the canister 14 is passed into the adsorbent chamber 46 which contains an adsorbent material 42 while the liquid fuel accompanying the fuel vapor is drawn by gravity to the fuel trap 48 above the chamber 46. At the liquid fuel trap 48, a seal is maintained between the fuel trap 48 and the adsorbent chamber 46 by creating a torturous path for the liquid molecules via a groove 50 inside the canister 14, into which the fuel trap 48 is pressed. The liquid fuel entrained with the fuel vapor from the fuel tank 12 is separated from the fuel vapor by gravity wherein the fuel vapor is directed to the adsorbent material 42 and the liquid fuel is directed to the fuel trap 48 where the liquid remains until it evaporates. The vapor from the liquid fuel trap 48 is directed into the bed of adsorbent material 42 in chamber 46 where it becomes adsorbed on the adsorbent material 42.

The fuel tank vapor load line 16 is connected to canister 14 via port 19. Engine purge line 17 is also connected to the canister 14 via port 20. Communication between the canister 14 and each of the fuel tank 12 and the engine 26 is controlled by valve 30. When the valve 30 is open between the fuel tank 12 and the canister 14, fuel vapor from the fuel tank 12 is transported to the canister 14 and when the valve 30 is open between the canister 14 and the engine 26, desorbed fuel vapor is drawn from the adsorbed material 42 in the canister 14 via vapor line 17 connected to the engine 26 by engine port 28 where the desorbed fuel vapor is consumed. The engine's vacuum serves to draw fresh air through the fresh air vent line 22 into the canister 14 for the purpose of desorbing fuel vapor from the bed of adsorbent material 42. The desorbed fuel vapor is then routed to the engine 26 through fuel vapor line 17 where it is consumed by the engine 26. The air drawn into the bed of adsorbent material 42 to desorb the fuel vapor is then vented to the atmosphere through fresh air line 22 connected to the canister 14 by fresh air vent port 24.

The liquid fuel trap 48 is located above the adsorbent material chamber 46 and separates any liquid fuel which is swept along with the fuel vapor into the canister 14. The fuel vapor separated from the liquid fuel continues on to the adsorbent material chamber 46 where it is adsorbed by the adsorbent material 42. The liquid fuel swept into the liquid fuel trap 48 is pulled there by gravity where it remains until it eventually evaporates. The vapor created by the evaporation of the liquid fuel then passes on to the bed of adsorbent material 42 where it becomes adsorbed, or it is purged to the engine 26 through fuel vapor line 17, depending on the direction of flow dictated by the engine controller 34 at the time.

The adsorbent material useful in the invention may be any of the conventional materials effective to adsorb hydrocarbon materials such as fuel vapor. Preferable, the adsorbent material is carbon and most preferably activated carbon. The carbon can be in any desired form but is typically in the form of carbon particles having an effective particle size sufficient to maximize the adsorbance of the fuel vapor in the canister.

While the present invention has been fully illustrated and described in detail, other designs, modifications and improvements will become apparent to those skilled in the art. Such designs, modifications and improvements are considered to be within the spirit of the present invention, the scope of which is determined only by the scope of the appended claims.

1. An evaporative emissions canister for use in an automotive evaporative emission system to control emission of fuel vapors to the atmosphere, the system including a fuel tank coupled to an automotive engine, said canister comprising:
a) a housing having at least one side wall, a top wall and a bottom wall;
b) a hydrocarbon vapor adsorbent chamber containing a hydrocarbon vapor adsorbing material disposed therein for adsorbing hydrocarbon fuel vapor flowing therethrough; and
c) a fuel trap located adjacent said vapor adsorbent chamber for separating liquid fuel from said fuel vapor and receiving said liquid fuel.

2. The canister of claim 1 wherein said liquid fuel trap diverts said fuel vapor entering said canister to said vapor adsorbent chamber containing said hydrocarbon vapor adsorbing material.

3. The canister of claim 1 wherein said liquid fuel is diverted to said liquid fuel trap by gravity.

4. The canister of claim 1 wherein said liquid fuel trap is installed in said housing by press fitting said fuel trap to the housing such that said liquid fuel trap is sealed from the adsorbent chamber by a groove inside said housing which creates a tortuous path for molecules of said liquid fuel.

5. The canister of claim 1 wherein said hydrocarbon adsorbing material comprises carbon.

6. The canister of claim 5 wherein said carbon is activated carbon.

7. The canister of claim 1 further comprising a purge port in communication with an automotive engine to allow desorbed fuel vapor to flow thereto.

8. The canister of claim 1 further comprising a vent port through which air is vented to the atmosphere upon adsorption of fuel vapor and for admitting air upon desorption of fuel vapor during purging.

9. The canister of claim 3 wherein said liquid fuel in said liquid fuel trap is subjected to evaporation.

10. The canister of claim 9 wherein the evaporated liquid fuel in the form of fuel vapor is directed to said adsorbent chamber.

11. The canister of claim 9 wherein said evaporated liquid fuel in the form of fuel vapor is directed to the automotive engine.

12. An evaporative emissions canister for use in an automotive evaporative emission system to control emission of fuel vapors to the atmosphere, the system including a fuel tank coupled to an automotive engine, said canister comprising:
a) a housing having at least one side wall, a top wall and a bottom wall;
b) a first port in operable communication with said housing, through which fuel vapor containing liquid hydrocarbon fuel is received from the fuel tank;
c) a liquid fuel trap in operable communication with said housing for receiving said liquid hydrocarbon fuel;
d) a vapor adsorbent chamber containing a bed of carbon for adsorbing said hydrocarbon fuel vapor;
e) a second port in operable communication with said housing through which desorbed fuel vapor from the adsorbent chamber is directed to the engine where said fuel vapor is consumed;
f) a third port in operable communication with said housing through which air is vented to atmosphere upon adsorption of fuel vapor from said liquid fuel trap and for admitting air upon desorption of fuel vapor during a purging step.

13. The canister of claim 12 wherein said liquid hydrocarbon fuel is diverted to said liquid fuel trap by gravity.

14. The canister of claim 12 wherein said desorbed hydrocarbon fuel vapor is directed to said automotive engine via an engine vacuum line.

15. The canister of claim 12 wherein said evaporated liquid hydrocarbon fuel in the form of hydrocarbon fuel vapor is directed to said adsorbent chamber.

16. The canister of claim 12 wherein said fuel trap is installed in said housing by press fitting the fuel trap in the housing such that the fuel trap is sealed from said adsorbent chamber by a groove inside said housing which creates a tortuous path for molecules of said liquid fuel.

17. In an automotive evaporative emission system including a fuel tank coupled to an automotive engine wherein the evaporative emissions system includes an evaporative emissions canister to control emission of fuel vapors to the atmosphere, the improvement wherein said evaporative emissions canister includes a liquid fuel trap integrally formed in the evaporative emissions canister and a vapor adsorbent chamber containing a bed of adsorbent carbon, wherein a first hydrocarbon fuel from the fuel tank, said first hydrocarbon fuel comprising hydrocarbon fuel vapor containing liquid hydrocarbon fuel entrained therein is separated from the liquid hydrocarbon fuel and directed to said adsorbent chamber containing said bed of adsorbent carbon and said liquid hydrocarbon fuel is directed to said liquid fuel trap, said liquid fuel trap located adjacent to said adsorbent chamber, said hydrocarbon fuel vapor remaining in said adsorbent chamber until the adsorbent carbon bed becomes saturated, at which time the hydrocarbon fuel vapor is directed to the automotive engine through a purge port; and the liquid hydrocarbon fuel separated from the hydrocarbon fuel vapor is directed by gravity to said fuel trap where it remains until the liquid hydrocarbon fuel is evaporated forming a second hydrocarbon fuel vapor, the second hydrocarbon fuel vapor being directed to the adsorbent carbon bed or being directed, along with the first hydrocarbon fuel vapor, to the automotive engine through the purge port.

18. The automotive evaporation emissions system of claim 17 wherein said evaporative emissions canister comprises:
a) a vapor adsorbent chamber; and
b) a liquid fuel trap, wherein said liquid fuel trap is installed in said housing by press fitting said fuel trap in said housing such that the fuel trap is sealed from said adsorbent chamber by a groove inside said housing which creates a tortuous path for molecules of said liquid fuel.
